(19) United States
(12) Patent Application Publication
(10) Pub. No.: US 2007/0120798 A1
(43) Pub. Date: May 31, 2007

(54) Liquid crystal display panel and driving method for liquid crystal display panel

(76) Inventors: Seok Lyul Lee, Tao-Yuan Hsien (TW); Po Sheng Shih, Tao-Yuan Hsien (TW)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/657,640

(22) Filed: Jan. 25, 2007

Related U.S. Application Data
(63) Continuation of application No. 10/790,824, filed on Mar. 3, 2004.

(30) Foreign Application Priority Data
Oct. 15, 2003 (TW) 092128619

(51) Int. Cl. G09G 3/36

(52) U.S. Cl. 345/92

(57) ABSTRACT

A couple of scanning signals are applied to a pixel on the liquid crystal display panel. The scanning signals allows voltage to be separately written into a control electrode and a pixel electrode during two adjacent horizontal scanning periods or a vertical scanning period, and a coupled voltage is induced on the control electrode due to the potential variation of the pixel electrode during the next horizontal scanning period.

### CROSS REFERENCE TO RELATED APPLICATIONS

This application is a Continuation of application Ser. No. 10/790,824 filed Mar. 3, 2004, which claims foreign priority from Taiwanese Patent Application No. 09128619 filed Oct. 15, 2003.

### BACKGROUND OF THE INVENTION

1. Field of the Invention

The prevented invention relates to a liquid crystal display panel and a driving method for a liquid crystal display panel, especially relates to a method to drive the potential of a control electrode higher than the potential of a pixel electrode.

2. Description of the Related Art

With the wide applications of liquid crystal display (LCD) panels, users have more and more demands about the quality of the LCD panel, such as high brightness, high contrast, high resolution, high color saturation and fast response time. Especially as the panel size increases, the LCD panels have generally been applied to household flat displays, such as liquid crystal (LC) TV sets, which have become an important application of the LCD panels. Most of the general, traditional LCD panels have narrow view angles so the normal images displayed by them only can be viewed directly in front of the display area. If we watch the display area from an oblique view angle, color distortion occurs in what we watch, and even gray inversion occurs. That is, what appears black is actually white and what appears white is actually black. Therefore, how to widen the view angle is an important subject for the LCD manufacturers.

Among various methods for widening the view angle, an LC Vertical Alignment (VA) technique is still one of the most popular techniques in the current LCD market. However, because liquid crystal molecules are aligned in the same direction (mono-domain vertical alignment), we also cannot see a normal image from the view angle perpendicular to or symmetric to the direction. No matter when the liquid crystal molecules are realigned in a different direction after the electrical field existing therein changes, the view angle is also limited to the parallel direction of the liquid crystal molecules. Therefore, a multi-domain VA technique was put forth to improve the drawback of the prior art, hence the quality of various view angles is assured. Japanese Fujitsu Corporation once tried to form ridges or bumps on the color filter, and use the oblique boundary generated by bumps to control the alignment of the tilt direction of liquid crystal molecules automatically align tilt direction according to where region their belong to. But because the existence of the bumps results in that the precise alignment between a color filter and an active matrix substrate is necessary, and an additional over coating is necessarily formed on the color filter, the yield of this LCD panel becomes worse and the cost thereof increases.

FIG. 1 is a cross-sectional diagram of a conventional LCD display panel with a bias-bending vertical alignment (BBVA) type. The LCD panel 10 comprises a color filter 11, a liquid crystal layer 12 and an active matrix substrate 13. The color filter 11 and active matrix substrate 13 have a transparent substrate 111 and 131 respectively. A main electric field exists between the common electrode 112 formed on the color filter 11 and the pixel electrode 134 formed on the active matrix substrate 13, and a pair of symmetrically oblique electric fields exists between a control electrode 133 and the pixel electrode 134 together formed on the active matrix substrate 13 to make liquid crystal molecules 121 have oblique positions. There is another insulation layer 132 interposed between the control electrode 133 and the pixel electrode 134.

But when V_{CE}<V_{com}<V_{P} is satisfied, a declination line is brought into existence in the center of an area B, wherein V_{CE}, V_{com} and Vₚ represent the potentials of the control electrode, common electrode and pixel electrode respectively. The existence of the declination line result in that the liquid crystal layer 12 has a lower transmission ratio, a longer response time and an unstable status. In order to avoid the occurrence of these negative phenomena, it is expect that the following criteria should be satisfied during polarity inversion:

Criterion 1: If the current pixel is a positive frame, then V_{CE}>Vₚ>V_{com}; and

Criterion 2: If the current pixel is a negative frame, then V_{CE}<Vₚ<V_{Com}.

FIG. 2 is an equivalent circuit diagram of a pixel proposed by Korean Samsung Electronics Cooperation. The circuit of pixel 20 can satisfy aforesaid criteria to eliminate declination lines. One electrode of the first thin film transistor T₁″ is connected to a data line 262, and the gate electrode of it is driven by the scanning line 252. When the first thin film transistor T₁″ is turned on, the data signal of the data line 262 is written into a pixel electrode 24. One electrode of the second thin film transistor T₂″ is connected to a data line 261, and the gate electrode of it is driven by a scanning line 251. When the second thin film transistor T₂″ is turned on, the data signal of the data line 261 is written into a control electrode 23. One electrode of the third thin film transistor T₃″ is connected to the data line 262, and the gate electrode of it is driven by the scanning line 251. When the third thin film transistor T₃″ is turned on, the data signal of the data 262 is written into the pixel electrode 24.

In the pixel 20, a liquid crystal capacitor C₁″ exists between the pixel electrode 24 and common electrode 27, a Bias-Bending capacitor C₂″ exists between the control electrode 23 and pixel electrode 24, and a capacitor C₃″ exists between the control electrode 23 and the common electrode 27. Therefore, we obtain the following formula:

$${V}_{CE} = \frac{{C}_{2}^{″}}{{C}_{2}^{″} + {C}_{3}^{″}} ( {V}_{d 1} + {V}_{d 3} ) + {V}_{d 2} ,$$

wherein V_{d1}, V_{d2} and V_{d3} respectively represents the potentials of pixels, dividedly placed on coordinate (n, m), coordinate (n−1,m−1) and coordinate (n−1,m), to which the data signals are respectively applied. Meantime, we obtain an equation V_{CE}−V_{P}=V_{d2}+V_{d3} to satisfy Criteria 1 and 2. However, because each of the pixels 20 includes three thin film transistors, only if one of the thin film transistors is damaged, the pixel is considered to be malfunctioning. Therefore, the manufacture yield of this LCD cannot meet an acceptable standard currently. On the other hand, the number of the thin film transistors connected to a same scanning line is too much so as to result in a severe RC delay on the scan signal. The foresaid problems have to be further resolved.

### SUMMARY OF THE INVENTION

The first objective of the present invention is to provide a liquid crystal display panel. The polarity of a control electrode synchronously changes with the polarity of the pixel. When the polarity of the pixel is positive, the potential of the control electrode is higher than that of the pixel electrode; when the polarity of pixel is negative, the potential of control electrode is lower than that of the pixel electrode.

The second objective of the present invention is to provide a driving method for a liquid crystal display panel. The polarity of a control electrode synchronously changes with the polarity of the pixel. When the polarity of the pixel is positive, the potential of the control electrode is higher than that of the pixel electrode; when the polarity of pixel is negative, the potential of control electrode is lower than that of the pixel electrode.

In order to achieve the objective, the present invention discloses a driving method for a liquid crystal display panel. A couple of scanning signals are applied to a pixel on the liquid crystal display panel. The scanning signals allows voltage to be separately written into a control electrode and a pixel electrode during two adjacent horizontal scanning periods or a vertical scanning period, and a coupled voltage is induced on the control electrode due to the potential variation of the pixel electrode during the next horizontal scanning period.

Furthermore, a liquid crystal display panel is provided, which includes an active matrix substrate having a plurality of thin film transistors. The active matrix substrate comprises a plurality of parallel scanning lines and a plurality of parallel data lines, which cross mutually and form a plurality of pixels. Each of the pixels includes the first thin film transistor, the second thin film transistor, a control electrode (CE) and a pixel electrode. The first electrode of the first thin film transistor is connected to the data line; the second electrode of it is connected to the pixel electrode; the gate electrode of it is connected to the scanning line. The first electrode of the second thin film transistor is connected to another adjacent data line; the second electrode of it is connected to the control electrode, and the gate of it is connected to another adjacent scanning line. The scanning signals driving the pixel allows the control electrode and the pixel electrode to be written into their potentials during two horizontal scanning periods or during a vertical scanning period respectively. The gate electrode of first thin film transistor of the pixel located in a middle pixel row is connected to the gate electrode of second thin film transistor of the pixel located in a next pixel row and the gate electrode of second thin film transistor of the pixel located in the middle pixel row is connected to the gate electrode of first thin film transistor of the pixel located in a previous pixel row.

### BRIEF DESCRIPTION OF THE DRAWINGS

The invention will be described according to the appended drawings in which:

FIG. 1 is a cross-sectional diagram of a conventional LCD display panel with a bias-bending vertical alignment (BBVA) type;

FIG. 2 is an equivalent circuit diagram of a pixel proposed by Korean Samsung Electronics Cooperation;

FIG. 3 is an equivalent circuit diagram of the pixel of an LCD panel in accordance with the present invention;

FIG. 4 is a waveform diagram of driving signals applied to the pixel in FIG. 3;

FIG. 5 is an equivalent circuit diagram of the pixel of an LCD panel in accordance with another embodiment of the present invention; and

FIG. 6 is a waveform diagram of driving signals applied to the pixel in FIG. 5.

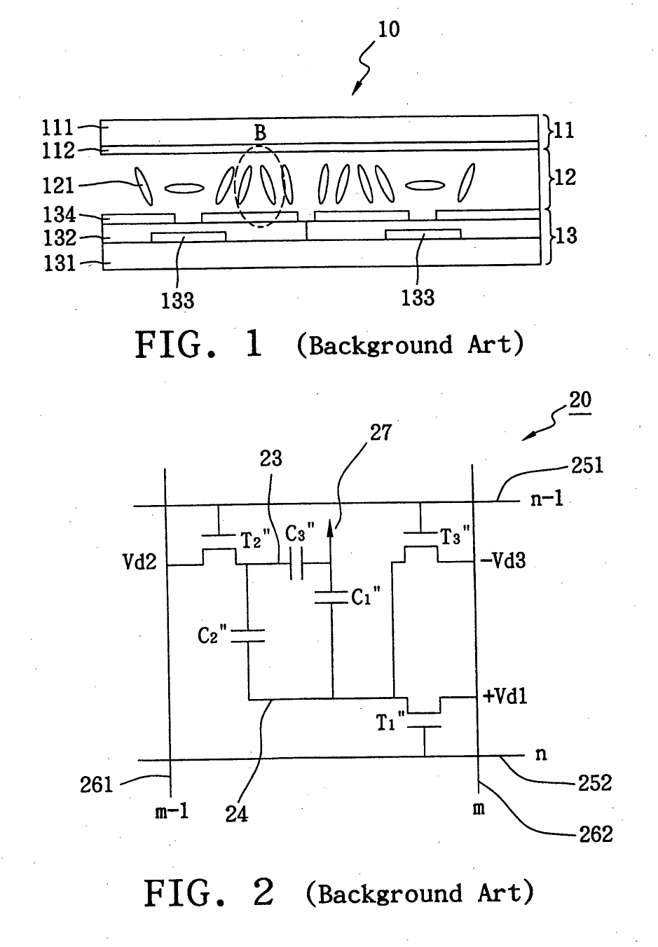

### PREFERRED EMBODIMENT OF THE PRESENT INVENTION

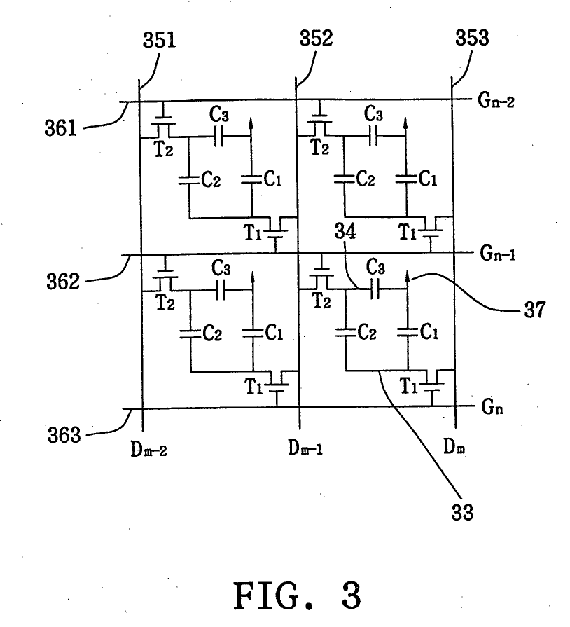

FIG. 3 an equivalent circuit diagram of the pixel of an LCD panel in accordance with the present invention. Only four adjacent pixels are shown in FIG. 3, which are formed by scanning lines 361, 362 and 363 (representing Gₙ₋₂, Gₙ₋₁, and Gₙ respectively) crossing data lines 351, 352 and 353 (representing Dmₘ₋₂, Dₘ₋₁ and Dₘ respectively). Each pixel includes a first thin film transistor T₁, a second thin film transistor T₂, a control electrode 34 and a pixel electrode 33 for the pixel at the intersection of the data line 353 and scanning line 363. The first electrode of the first thin film thin film transistor T₁ is connected to a data line 353, the second electrode of it is connected to the pixel electrode 33, and the gate electrode of it is connected to a scanning line 363. The first electrode of the second thin film transistor T2 is connected to another adjacent data line 352, the second electrode of it is connected to the control electrode 34, and the gate electrode of it is connected to a scanning line 362. In the pixel configuration of the presented invention, a liquid crystal capacitor C₁ exists between the pixel electrode 33 and a common electrode 37, a bias-bending capacitor C₂ exists between the control electrode 34 and the pixel electrode 33, and further a capacitor C₃ is formed between the control electrode 34 and the common electrode 37.

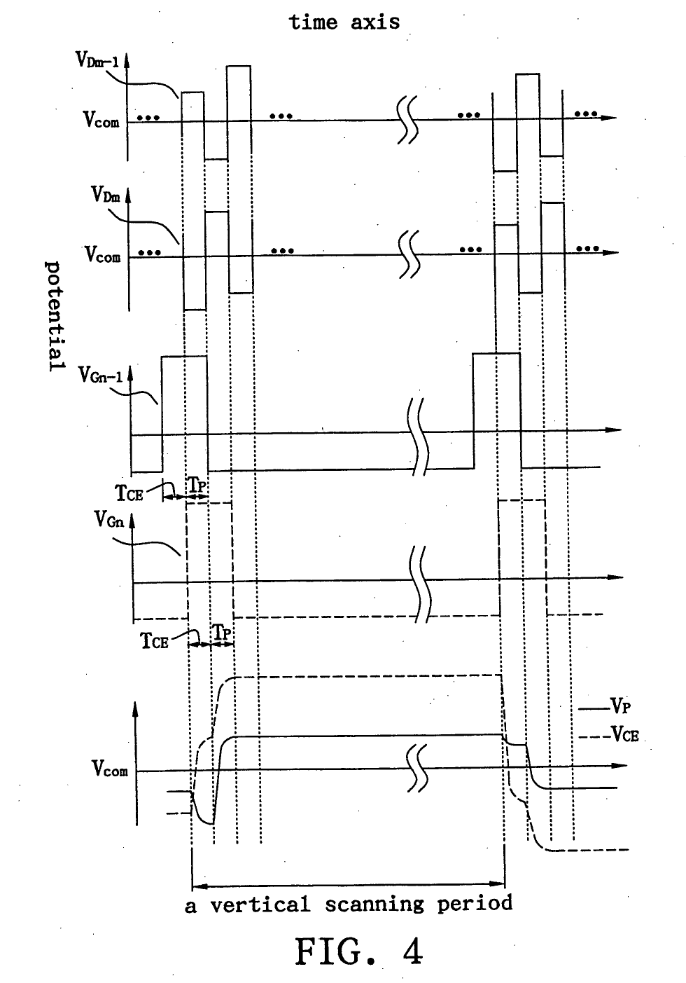

FIG. 4 is a waveform diagram of driving signals applied to the pixel in FIG. 3. V_{Dm-1} and V_{Dm} represent the data signals applied to the data lines 352 and 353, respectively, and V_{Gn-1} and V_{Gn} represent the scan signals applied to the scanning lines 362 and 363, respectively. The scanning waveform during each vertical scanning period includes a first waveform in a T_{CE} interval and a second waveform in a T_{P} interval.

The waveform the lowest row in FIG. 4 is the variations of the corresponding potentials of the pixel placed at the intersection of the scanning line 363 and the data line 353, wherein V_{P} and V_{CE} represent the potential of the pixel electrode 33 and control electrode 34, respectively. During the preceding interval T_{CE} on the scanning signal V_{Gn}, the second thin film transistor T₂ is turned on by the scanning signal V_{Gn-1}, and then the data signal V_{Dm-1} is written into the control electrode 34. As shown in FIG. 4, the potential of the control electrode 34 change from an initial potential (lower than V_{com}) to the same potential as the data signal V_{Dm-1} (higher than V_{com}). At the same time, because the first thin film transistor T₁ is turned on by V_{Gn}, the potential (lower than V_{com}) of the data signal V_{Dm} is written into the pixel electrode 33. During the succeeding interval T_{P} on the scanning signal V_{Gn}, the first thin film transistor T₁ is turned on by the scanning signal V_{Gn}, and then the potential (higher than V_{com}) of the data signal V_{Dm} is written into the pixel electrode 33. Meanwhile, because the second thin film transistor T₂ is turned off, the control electrode 34 is in a floating state, while the potential of the control electrode 34 is advanced to a higher level due to a capacitively coupled effect.

From FIG. 4, it is clear that when the polarity of the pixel is positive, Criterion 1 V_{CE}>V_{P}>V_{com} is satisfied. After the vertical scanning period terminating, because the polarity of the pixel changes to negative, Criterion 2 V_{CE}<V_{P}<Vcom is also satisfied accordingly.

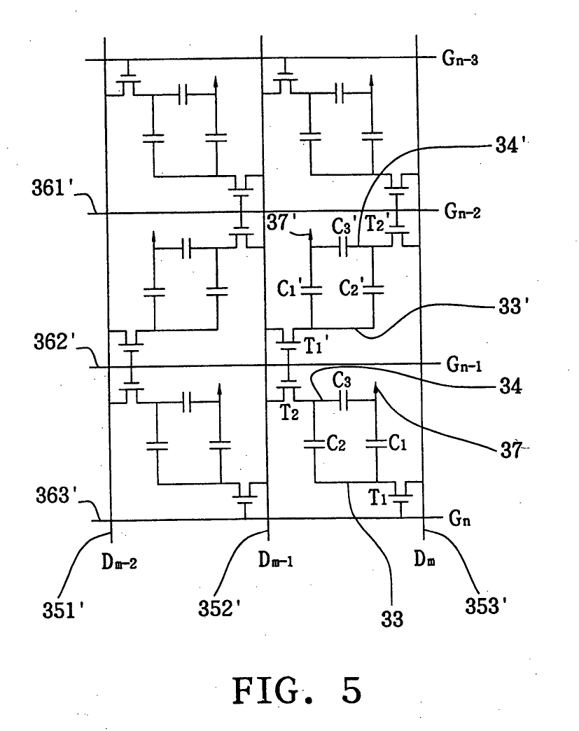

FIG. 5 is an equivalent circuit diagram of the pixel of an LCD panel in accordance with another embodiment of the present invention. The configuration of the pixel connected to a scanning line 363′ is given as following: the first electrode of the first thin film transistor T₁ is connected to a data line 353′, the second electrode of it is connected to a pixel electrode 33, and the gate electrode of it is connected to a scanning line 363′; the first electrode of the second thin film transistor T₂ is connected to another adjacent data line 352′, the second electrode of it is connected to a control electrode 33, and the gate electrode of it is connected to a scanning line 362′. As the configuration in FIG. 5 shows, a liquid crystal capacitor C₁ exists between the pixel electrode 33 and a common electrode 37, a bias-bending capacitor C₂ exists between the control electrode 34 and the pixel electrode 33, and further a capacitor C₃ is formed between the control electrode 34 and the common electrode 37.

The configuration of the pixel connected to the scanning line 362′ is horizontally symmetric to the configuration of the pixel connected to the scanning line 363′, and is given as follows: the first electrode of the first thin film transistor T₁′ is connected to the data line 352′, the second electrode of it is connected to a pixel electrode 33′, and the gate electrode of it is connected to the scanning line 362′; the first electrode of the second thin film transistor T₂′ is connected to another adjacent data line 353′, the second electrode of it is connected to a control electrode 34′, and the gate electrode of it is connected to a scanning line 361′. A liquid crystal capacitor C₁′ exists between the pixel electrode 33′ and a common electrode 37′, a bias-bending capacitor C₂′ exists between the control electrode 34′ and the pixel electrode 33′, and further a capacitor C₃′ is formed between the control electrode 34′ and the common electrode 37′.

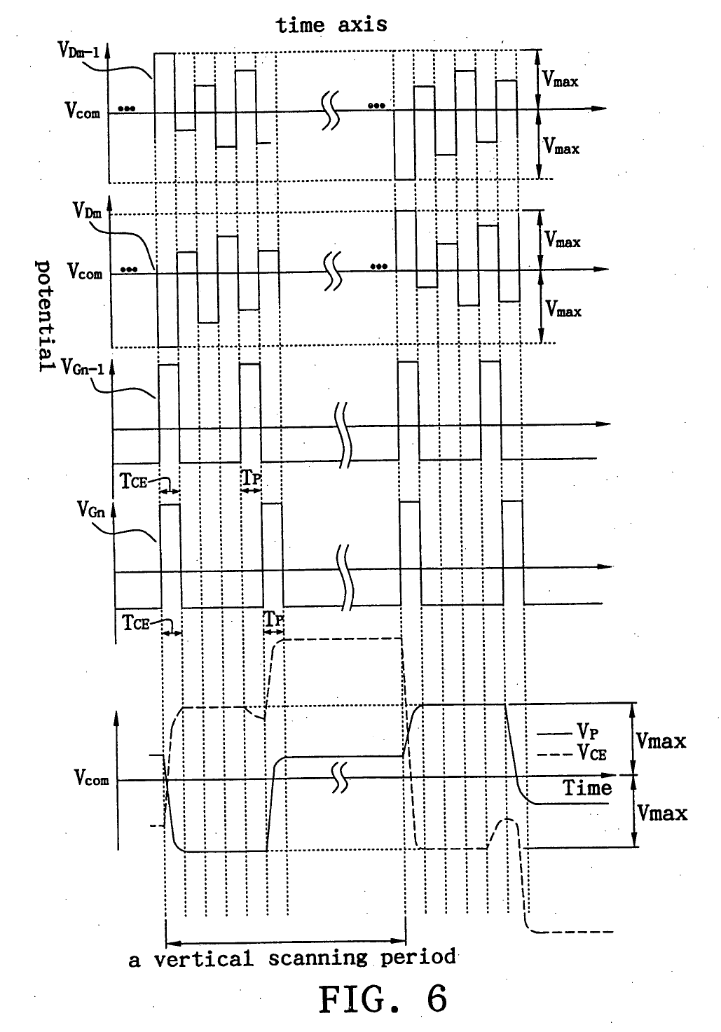

FIG. 6 is a waveform diagram of driving signals applied to the pixel in FIG. 5. V_{Dm-1}, and V_{Dm} represent the data signals applied to the data lines 352′ and 353′, respectively, and V_{Gn-1}, and V_{Gn} represent the scan signals applied to the scanning lines 362′ and 363′, respectively. The scanning waveform during a vertical scanning period includes two parts. That is, the data signals V_{Dm-1}and V_{Dm} are respectively written into the control electrode 34 and 34′ during an interval T_{CE}, and the data signals V_{Dm} and V_{Dm-1} are respectively written into the pixel electrodes 33 and 33′ during an interval T_{P}.

The first pulses of the scanning signals V_{Gn} and V_{Gn-1} are active at the same horizontal scanning period, which is equal to the interval T_{CE}. When the potential of V_{Dm-1} is higher than that of V_{com}, the data signal V_{Dm-1} is allowed to be written into the control electrode 34 after the second thin film transistor T₂ is turned on. Meanwhile, the potential of V_{Dm-1} is equal to V_{com} plus Vₘₐₓ representing the maximum voltage between the potential of the data signals and the potential of the common electrode. Therefore, the potential of the control electrode 34 changes to a higher level the same as that of the data signal V_{Dm-1} from a lower level. Meanwhile, the potential of data signal V_{Dm} is at a lower level, and the data signal V_{Dm} is also written into the pixel electrode 33, wherein the potential of V_{Dm} is equal to V_{com} minus Vₘₐₓ.

The second pulses of the scanning signals V_{Gn-1} and V_{Gn} are respectively active at two adjacent horizontal scanning periods, i.e., the intervals T_{P}. The high potential of the second pulse on the scanning signal V_{Gn-1} turns on the second thin film transistor T₂; meanwhile, the potential of the data signal V_{Dm-1} is written into the control electrode 34. Then the high potential of the second pulse on the scanning signal V_{Gn} turns on the first thin film transistor T₁; meanwhile, the high potential of the data signal V_{Dm} is written into the pixel electrode 33. Because the second thin film transistor T₂ is turned off at this time, the control electrode 34 is in a floating state; consequently, the potential V_{CE} of the control electrode 34 advanced to a higher level due to a capacitively coupled effect. Because the capacitance of the capacitor C₃ is far less than that of that of the capacitors C₁ and C₂, for the pixels placed at the intersection of the scan line 3.63′ and the data line 353′, a formula is given as follows:

$${V}_{CE} - {V}_{p} ≅ \pm \frac{( {C}_{1} + 2 {C}_{2} ) {V}_{max} + {C}_{1} \times \vert {V}_{Pn - 1} \vert}{{C}_{1} + {C}_{2}} ,$$

wherein Vₘₐₓ, represents the maximum voltage between the potential of the data signals and the potential of the common electrode, and V_{Pn-1} represents the voltage of the pixel electrode at the intersection of the scanning line 362′ and the data line 352′ against the potential V_{com}.

From FIG. 6, it is clear that when the polarity of pixel is positive, except for an ignorable interval, Criterion 1 V_{CE}>V_{P}>V_{com} is satisfied during most of the remaining period. After a vertical scanning period terminating, the polarity of the pixel changes to negative, then Criterion 2 V_{CE}<V_{P}<V_{com} is satisfied during most of another vertical scanning period.

The whole screen of the LCD panel can be divided into several groups according to the scanning lines, and each group has several adjacent scan lines, such as two, three and four adjacent scanning lines. The intervals T_{CE} of the scanning lines in the same group appear on the same horizontal scanning period.

The above-described embodiments of the present invention are intended to be illustrative only. Numerous alternative embodiments may be devised by persons skilled in the art without departing from the scope of the following claims.

What is claimed is:

1. A driving method for a liquid crystal display panel, comprising the steps of:
applying a couple of scanning signals to a pixel on the liquid crystal display panel, wherein the scanning signals allows voltages to be separately written into a control electrode and a pixel electrode during two adjacent horizontal scanning periods or a vertical scanning period, and a coupled voltage is induced on the control electrode due to a potential variation of the pixel electrode during the next horizontal scanning period or the vertical scanning period.

2. The driving method for a liquid crystal display panel of claim 1, wherein the pixel on the liquid crystal display panel includes the control electrode, the pixel electrode and two thin film transistors.

3. The driving method for a liquid crystal display panel of claim 1, wherein one of the couple of scanning signals during the previous horizontal scanning period controls voltage to be written into the control electrode, and the other scanning signal during the next horizontal scanning period controls voltage to be written into the pixel electrode.

4. The driving method for a liquid crystal display panel of claim 1, wherein the potential of the control electrode is higher than the potential of the pixel electrode when the polarity of the pixel is positive.

5. The driving method for a liquid crystal display panel of claim 1, wherein the potential of the control electrode is lower than the potential of the pixel electrode when the polarity of the pixel is negative.

6. The driving method for a liquid crystal display panel of claim 1, wherein the liquid crystal display panel is divided into several groups according to the pixels on a plurality of scanning lines, and the scanning signals on the plurality of scanning lines allow corresponding potentials to be written into the control electrodes simultaneously.

7. A driving method for a liquid crystal display panel, comprising the step of:
applying at least a first scanning signal and a second scanning signal to a pixel on the liquid crystal display panel, wherein there exists a duration during two adjacent horizontal periods or a vertical scanning period at which the first scanning signal and the second scanning signal simultaneously make corresponding voltages to be written into a control electrode and a pixel electrode.

8. The driving method for a liquid crystal display panel of claim 7, wherein the pixel on the liquid crystal display panel includes the control electrode, the pixel electrode and two thin film transistor.

9. The driving method for a liquid crystal display panel of claim 7, wherein the first scanning signal during the previous horizontal scanning period controls voltage to be written into the control electrode, and the second scanning signal during the next horizontal scanning period controls voltage to be written into the pixel electrode.

10. The driving method for a liquid crystal display panel of claim 9, wherein a coupled voltage is induced on the control electrode due to the potential variation of the pixel electrode during the next horizontal scanning period or the vertical scanning period.

11. The driving method for a liquid crystal display panel of claim 7, wherein the potential of the control electrode is higher than the potential of the pixel electrode when the polarity of the pixel is positive.

12. The driving method for a liquid crystal display panel of claim 7, wherein the potential of the control electrode is lower than the potential of the pixel electrode when the polarity of the pixel is negative.

13. The driving method for a liquid crystal display panel of claim 7, wherein the liquid crystal display panel is divided into several groups according to the pixels on a plurality of scanning lines, and the scanning signals on the plurality of scanning lines allow corresponding potentials to be written into the control electrodes simultaneously.

14. A liquid crystal display panel, comprising:
at least one common electrode;
a plurality of scanning lines for transmitting scanning signals, wherein a portion of the scanning signal of the scanning line and a portion of the scanning signal of the adjacent scanning are active at the same time during a vertical scanning period;
a plurality of data lines; and
a plurality of pixels formed at the intersection of the scanning lines and data lines, each of the pixels including:
(a) a pixel electrode;
(b) a control electrode;
(c) a first thin film transistor having a gate electrode connected to the scanning line, a first electrode connected to the data line and a second electrode connected to the pixel electrode; and
(d) a second thin film transistor having a gate electrode connected to another adjacent scanning line, a first electrode connected to another adjacent data line and a second electrode connected to the control electrode.

15. The liquid crystal display panel of claim 14, wherein the gate electrode of the first thin film transistor of the pixel located in a pixel row is electrically connected to the gate electrode of the second thin film transistor of the adjacent pixel located in an adjacent pixel row.

16. The liquid crystal display panel of claim 14, wherein each of the scanning signals includes a first portion and a second portion during a vertical scanning period.

17. The liquid crystal display panel of claim 16, wherein the first portion and the second portion are included in a pulse.

18. The liquid crystal display panel of claim 16, wherein the first portion and the second portion are two individual pulses.

19. The liquid crystal display panel of claim 16, wherein the first portions of the two adjacent scanning lines are active at the same time.

20. The liquid crystal display panel of claim 16, wherein the first portion of the scanning line and the second portion of the adjacent scanning line are active at the same time.
